(19) United States
(12) Patent Application Publication
(10) Pub. No.: US 2010/0222955 A1
(43) Pub. Date: Sep. 2, 2010

(54) ELECTRONIC CONTROL SYSTEM FOR A VEHICLE

(76) Inventor: John Phillip Chevalier, London (GB)

Correspondence Address: DICKSTEIN SHAPIRO LLP, 1825 EYE STREET NW, Washington, DC, 20006-5403, US

(21) Appl. No.: 12/160,077

(22) PCT Filed: Jan. 11, 2007
(86) PCT No.: PCT/GB2007/000073

§ 371 Date: Jul. 3, 2008

(30) Foreign Application Priority Data
Jan. 23, 2006 (GB) 0601343.7

(51) Int. Cl. B60W 10/00; B60W 10/20; B60W 10/30

(52) U.S. Cl. 701/29

(57) ABSTRACT

An electronic control system for a vehicle having plural device actuators, each device being configured to provide an output signal indicative of its actuation status, the vehicle also having inputs for requesting actuation of the respective devices and generating corresponding actuation request signals, and vehicle condition sensors for providing vehicle condition signals indicative of vehicle parameters such as speed and tilt or the status of vehicle components; the system comprising: a slave controller associated with each device; and a master controller; the master and slave controllers all being connected to receive the vehicle condition signals, the master controller being connected to receive the actuation request signals and to receive the status output signals from all the devices and being in two-way data communication with all the slave controllers, and each slave controller being connected to receive a corresponding actuation request signal and to receive power from the master controller and to provide power to its respective device; each slave controller being responsive to an actuation request signal requesting actuation of its device to send a slave request signal to the master controller, and the master controller being responsive to the slave request signal provide a master consent signal to the slave controller only if it has independently received the same actuation request signal and it determines that it is safe and appropriate to do so, and to supply power to the slave controller; and the slave controller being responsive to the master consent signal and the relevant vehicle condition signals and the respective status output signal to supply power to the device to control the actuation of the device only in the event that it determines that it is safe and appropriate to do so.

This invention relates to an electronic control system for safety or security critical devices and systems, and it is particularly useful in a vehicle for supplying power to electrical actuators such as a steering column lock or a door latch or a tailgate latch.

Safety is of paramount importance in vehicle electronic control systems, and it is important for example that doors should not be allowed to open electrically, or a steering column be locked electrically, whilst the vehicle is in motion. Modern vehicles have a large number of devices controlled electrically, and a large number of condition sensors at various places in the vehicle for sensing conditions such as engine management status, fuel supply rate, vehicle tilt, brake actuation status and vehicle speed. The purpose of the present invention is to provide a safe way of actuating devices in the vehicle using power from the battery or alternator, which significantly reduces the possibility of electrical malfunction as a result of wiring error, software faults or even deliberate interference.

The invention provides an electronic control system for a vehicle having plural device actuators, each device being configured to provide an output signal indicative of its actuation status, the vehicle also having inputs for requesting actuation of the respective devices and generating corresponding actuation request signals, and vehicle condition sensors for providing vehicle condition signals indicative of vehicle parameters such as speed and tilt or the status of vehicle components; the system comprising: a slave controller associated with each device; and a master controller; the master and slave controllers all being connected to receive at least some of the vehicle condition signals, the master controller being connected to receive the actuation request signals and to receive the status output signals from all the devices and being in two-way data communication with all the slave controllers, and each slave controller being connected to receive a corresponding actuation request signal and to receive power from the master controller and to provide power to its respective device; the master controller being arranged to supply power to the slave controller only if it has independently received a corresponding actuation request signal and it determines from the vehicle condition signals that it is safe and appropriate to do so; and the slave controller being responsive to an actuation request signal requesting actuation of its device, to any relevant vehicle condition signals and to the respective status output signal, to supply the power from the master controller to the device to control the actuation of the device only in the event that the slave controller determines from the said signals that it is safe and appropriate to do so.

The use of independent master and slave controllers, independently analysing vehicle condition and independently analysing a request for actuation, significantly reduces the likelihood of unsafe conditions arising, particularly when the master and slave controllers are arranged in separate parts of the vehicle and the slave controllers are housed adjacent their devices.

Having all the feedback signals emanating from the devices (e.g latches) ignored when the vehicle is in motion would not alone be sufficient to safeguard against accidental or unsafe actuation. For example, it could be made impossible to lock or unlock and power release any of the doors if a signal were initiated in a latch whilst the vehicle is in motion (i.e. when the vehicle reaches a speed of 5 Km/h or so). However, this would not safeguard against software malfunctions or electrical faults in the slave or master circuitry without the help of such an arrangement as is specified in this invention. It is worth noting that unlike the function of electrical power door release, the functions of locking and unlocking whilst the vehicle is still in motion could still be made possible, if desired, by using either the locking switch inside the vehicle or the inertia switch (normally used to trigger the airbags and unlock all doors in case of a crash).

In order that the invention may be better understood, a preferred embodiment will now be described, with reference to the accompanying drawings, in which:

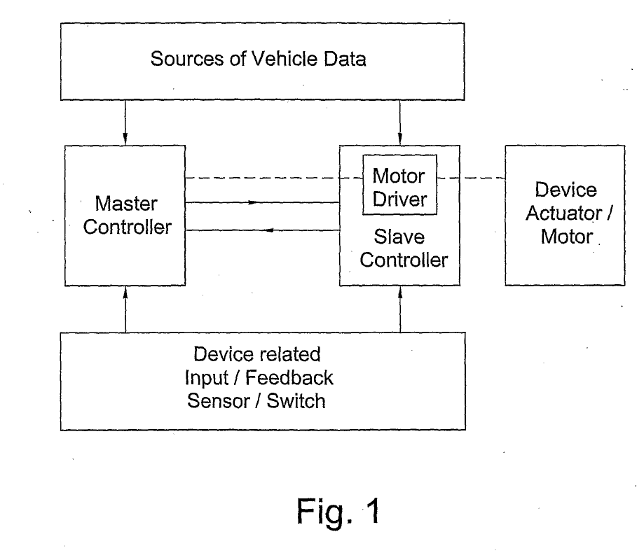

FIG. 1 is a diagram showing system data flow embodying the present invention;

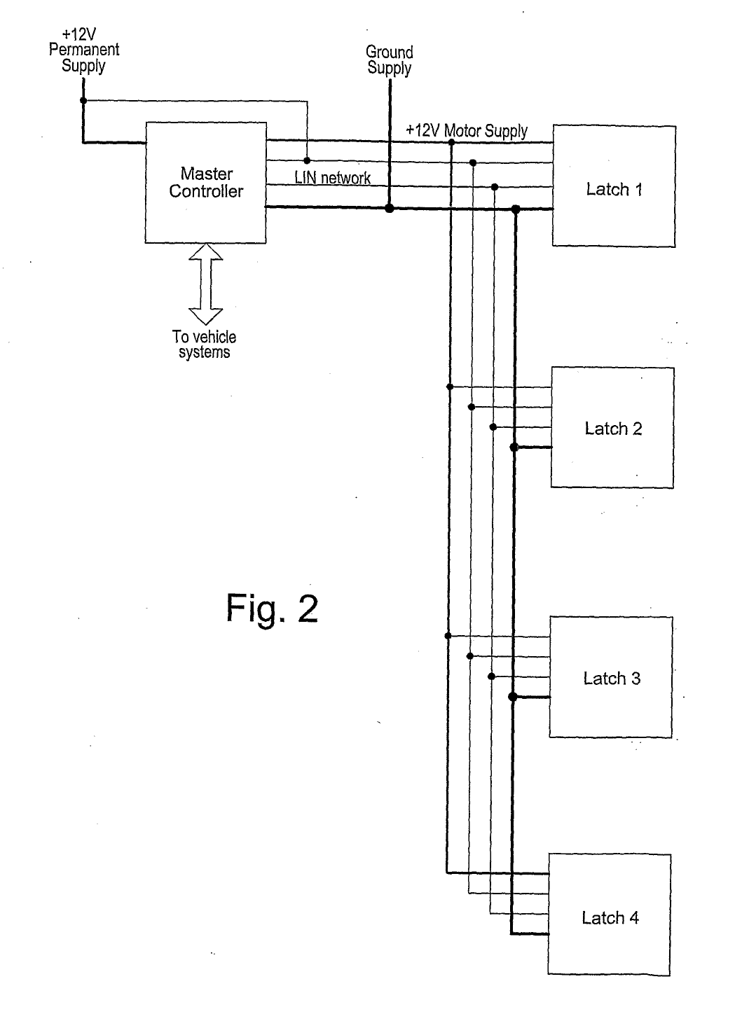

FIG. 2 shows part of the electronic system in a vehicle, embodying the invention;

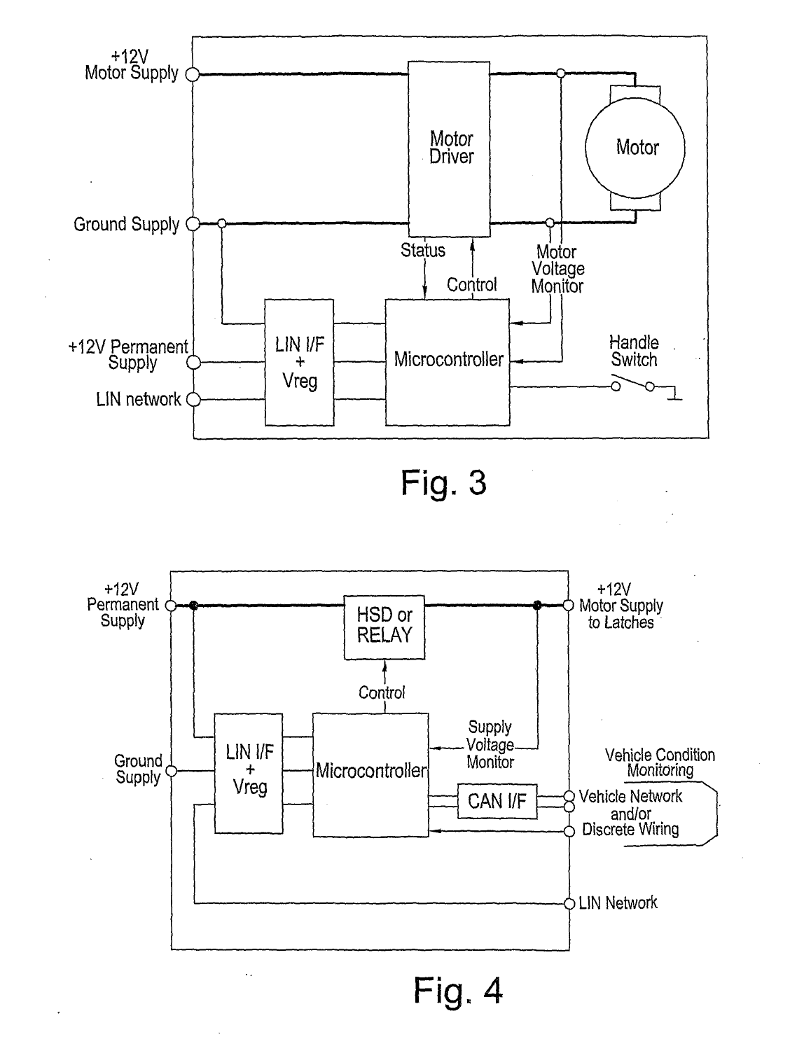

FIG. 3 shows a block diagram of a door latch forming part of the system of FIGS. 1 and 2; and

FIG. 4 is a block diagram of a master controller of the system of FIGS. 1 and 2.

As shown in FIG. 2, a vehicle has four door latches. These are examples of devices, and other examples would be an electrical steering column lock, which is also powered by an electric motor and which also has a sensor for providing an output signal indicative of its actuation status. Such output signals are provided to the system data network, as shown in FIG. 2. These sensors on board the devices could for example be electromechanical switches such as reed switches, micro-switches, inertia switches, and piezo-electric pressure pads, potentiometric switches or electromagnetic switches such as capacitive or inductive switches, or optical switches or solid state sensors such as Hall effect sensors, etc.

The conventional vehicle electronic control unit, shown as “sources of vehicle data” in FIG. 1, is connected to a plurality of vehicle condition sensors in the vehicle, which provide condition signals indicative of vehicle parameters such as speed and tilt or the status of vehicle components; these may sense brake actuation status and engine management status and fuel supply rate, for example.

As shown in FIGS. 2 and 4, there is a +12 volt permanent supply, connected to the vehicle battery and alternator control circuitry. The ground supply at 0 volts is connected to the vehicle structure.

In the example shown in FIG. 2, the permanent power supply is provided not only to the master controller but also to each of the devices, i.e. the four latches. However, this power supply to the devices is only for the purpose of powering the control circuitry, and not for powering the respective devices. Thus the permanent supply is connected to the slave controllers, shown as the micro-controller in FIG. 3, entirely separately from the power supply intended for the motor driver within the latch shown in FIG. 3. As shown in FIGS. 2, 3 and 4, the master controller of FIG. 4 selectively provides output power at +12 volts to each of the latches; control circuitry in the master controller ensures that this is provided only for a predetermined duration.

As shown in FIG. 3, the latch has an electric motor for actuating mechanical components, providing functionality such as door opening and locking. The latch may be controllable by other motive means such as a valve or solenoid. Electrical power to the motor is supplied by a motor driver, whose status is sent in the form of an electrical signal to the micro-controller which controls the motor driver. The voltage supply to the motor is monitored and fed back to the micro-controller as a signal. An input in the form of a switch provides a control signal to the micro-controller, indicative that the user of the vehicle wishes to open the door. This is illustrated in FIG. 1 as the flow of data from “device related input/feedback sensor/switch” to the slave controller.

The communication between the master and slaves may be by individual wires or by a serial link such as an industry standard network such as CAN (Controller Area Network) or LIN (Local Interconnect Network); or a bespoke network. The examples show the master and slaves sharing information over a IAN bus. The LIN Interface (LIN I/F) shown may be any suitable LIN bus driver circuit. The examples also show a typical arrangement for a local voltage regulator (VREG). The permanent power supply for the control circuits may be integrated into the control circuitry or supplied from an external regulator.

The master controller is shown in FIG. 4. This also responds to the vehicle condition, through vehicle network and/or discrete wiring supplied to the micro-controller. This controls the power to the actuators with a relay or electronic switch such as an HSD (High Side Driver). It is equally possible to isolate the power to the actuator by switching off the negative side of the actuator with a relay or electronic switch. This supply voltage is monitored and fed back as a signal to the micro-controller.

The micro-controller in the latch, shown in FIG. 3, is arranged to enter a sleep mode, with significantly reduced power consumption, whenever it detects that the vehicle is in motion. When it senses that it is safe for its device potentially to be actuated, for example when the vehicle is stationary and also when the brakes are applied and fuel supply rate is below a predetermined level, then it will wake up.

It will be understood that the motor driver can be located e.g. inside the latch as shown in FIG. 3, or else secured for example by bolts onto the outside of the latch or in a convenient location independent from the Master Controller. Inter-circuitry connections could be used, or cabling, or radio communications. In this way, electrical connections supplying power to the motor are not exposed, and this reduces the risk of interference by a thief, and of accidental short-circuits.

Separation of the master controller from the slave controllers helps reduce the risks of adverse effects of short circuits, and this may be achieved by providing the master controller in a separate housing, located in a different part of the vehicle, and linked for example by appropriate cables, or by radio communications using transceivers. However, the master controller may share the same housing with at least one slave controller, communicating with it or with them by inter-circuitry connections or by cabling.

The LIN bus is private within this electronic control system, dedicated to the security of the operation of the devices, and it is not connected to any other of the vehicle data systems.

The sequence of operations in the electronic control system of FIGS. 1 to 4 will now be described.

A request for actuation of a device is initiated in the individual device by the operation of a dedicated switch or for example by any other dedicated means such as a key fob or other system related input. At the same time, the master and slave controllers share specific predetermined data about the state of the vehicle, such as the speed of the car; the state of the engine; and the security status of the car such as whether it is locked or unlocked, whether the door is open, and whether the car alarm is on or off; and whether an engine immobiliser is active.

The data received by the master and slave controllers, indicative of vehicle condition, is passed on from the source directly and independently from any other controllers or systems that may be sharing the same data.

An independent actuation request by the slave controller is issued to the master controller which in turn compares this request with a similar request received independently by the master controller. This request must be seen at the same time by the master controller and the individual slave controller: these controllers have the same specific software parameters such as masking, polling and duration of actuation.

The master controller then allows power to be supplied to the specific slave controller, for a predetermined period of time, provided that it determines from the vehicle condition that it is safe and appropriate to do so.

This slave controller detects the availability of the current supplied from the master controller, and also detects the request from the master controller to effect actuation. The slave controller compares all corroborative data, including the independently-obtained request, and then initiates the actuation if everything appears to be safe and appropriate, the actuation being initiated according to the specific parameters programmed in the micro-processor.

A summary of the sequential actions taken by the slave and master controllers, all of which receive corresponding device status signals and at least some of the vehicle status signals, as appropriate, is given below:

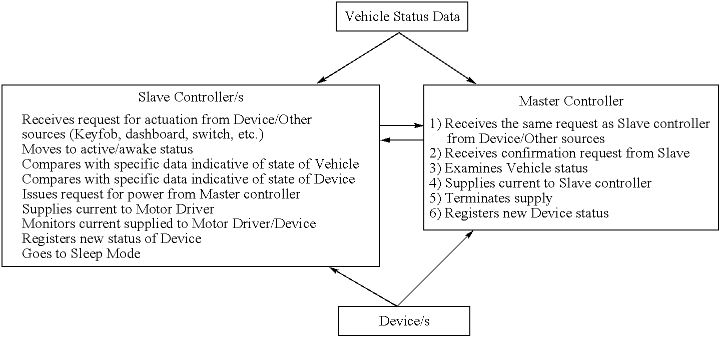

There are also self diagnostic procedures in the specific slave controllers and in the master controller relying on other data including for example the monitoring of the voltage and current being processed. These procedures are intended to detect errors. For example, one error is the motor power being supplied for too long: a master controller fault or a wiring fault. Another would be the exterior door handle switch being stuck: a mechanical or an electrical failure. A further error would be that the master controller cannot communicate with one of the latches: a wiring or latch failure. If the master controller cannot communicate with any latch, then this would be a system failure.

Accordingly, the likelihood of any failure causing unsafe or unintended actuation of any of the devices in the vehicle is negligible. A failure of the latch, attempting to drive the latch motor unexpectedly, will have no effect since the motor will not have any power. A failure in the master controller causing power to be supplied, together with a valid power-release request, will have no effect, since the latch will ignore it, having received no independent request itself. A physical or algorithmic fault, or conflicting data, in any of the controllers or input devices will not induce an actuation of the devices, because a precisely predetermined and sequential logic has to be followed always before electrical power is allowed to go through to the motor.

An advantage of the system embodying the present invention is that it can be fitted into vehicles with existing electronic systems. The monitoring of road speed, for example, is also used for the drive away lock-in feature, so it does not add additional cost to the vehicle.

In the case of attempted theft of the vehicle, it is theoretically possible for the engine immobiliser to be de-activated and for the external wiring of the latch to be interfered with by the application of electrical power, but this power would still not be relayed to the motors since the thief would not have access to the interior of the latch which contains the micro-controller and motor driver.

Again, even if there were an accidental short circuit across the master controller, a simultaneous short circuit across the motor driver would be extremely unlikely.

Whilst the preferred embodiment includes the provision of device status information for use by all the controllers, this is not essential and could be omitted. Further, the exchange of slave request and master consent signals, whilst preferred, is not essential.

1. An electronic control system for a vehicle having plural device actuators, the vehicle also having inputs for requesting actuation of the respective devices and generating corresponding actuation request signals, and vehicle condition sensors for providing vehicle condition signals indicative of vehicle parameters such as speed and tilt or the status of vehicle components;
the system comprising:
a slave controller associated with each device;
and a master controller;
the master and slave controllers all being connected to receive at least some of the vehicle condition signals, the master controller being connected to receive the actuation request signals from all the devices and being in two-way data communication with all the slave controllers, and each slave controller being connected to receive a corresponding actuation request signal and to receive power from the master controller and to provide power to its respective device;
the master controller being arranged to supply power to the slave controller only if it has independently received a corresponding actuation request signal and it determines from the vehicle condition signals that it is safe and appropriate to do so;
and the slave controller being responsive to an actuation request signal requesting actuation of its device and to any relevant vehicle condition signals, to supply the power from the master controller to the device to control the actuation of the device only in the event that the slave controller determines from the said signals that it is safe and appropriate to do so.

2. An electronic control system according to claim 1, in which the master controller is arranged to provide a master consent signal to the slave controller only in the event that it has independently received the corresponding actuation request signal and it determines from the vehicle condition signals that it is safe and appropriate to do so; and the slave controller is prevented from supplying power to the device unless it has received the master consent signal.

3. An electronic control system according to claim 2, in which each slave controller is responsive to the actuation request signal to send a slave request signal to the master controller, and the master controller provides the corresponding master consent signal only in response to the slave request signal.

4. An electronic control system according to claim 1, for use in a vehicle each of whose devices is configured to provide an output signal indicative of its actuation status, the master controller being responsive to the status output signal from any of the devices to determine whether it is safe and appropriate to supply the power to the corresponding device controller, and each slave controller being responsive to its respective device's status output signal to supply the power to the device only if it determines that it is safe and appropriate to do so.

5. An electronic control system according to claim 1, in which at least one of the devices is a latch powered by an electric motor.

6. An electronic control system according to claim 1, in which at least one of the devices is a steering column lock powered by an electric motor.

7. An electronic control system according to claim 1, in which at least one of the devices is controllable by motive means such as a valve or a solenoid.

8. An electronic control system according to claim 1, in which the slave controller is configured to enter and remain in a sleep mode, with reduced power consumption, when a vehicle condition signal is indicative of the vehicle being in motion.

9. An electronic control system according to claim 1, in which the vehicle condition sensors are arranged to sense vehicle speed, vehicle tilt, vehicle brake actuation, engine state, vehicle security status, or engine fuel supply rate, or any combination of the aforesaid conditions.

10. An electronic control system according to claim 1, comprising a power source connected to the master controller.

11. An electronic control system according to claim 10, in which the power source is also connected to the slave controllers, for the purpose of powering the slave controlling circuitry but not for the actuation of the corresponding devices.

12. An electronic control system according to claim 1, comprising the said vehicle condition sensors.

13. An electronic control system according to claim 1, comprising the said inputs for requesting actuation.

14. An electronic control system according to claim 13, in which the said inputs comprise a switch associated with a steering column lock.

15. An electronic control system according to claim 13, the said inputs comprising a switch associated with a door handle.

16. An electronic control system according to claim 1, in which the master controller is configured to supply power to the slave controller only for a predetermined period.

17. An electronic control system according to claim 1, in which the master controller and at least one slave controller share the same housing and communicate with each other through inter-circuitry connections or cabling.

18. An electronic control system according to claim 1, in which the master controller is housed separately from the slave controllers and is connected to the slave controllers by cabling.

19. An electronic control system according to claim 1, in which the slave controllers are housed separately from their devices and are capable of radio communication with them.

20. An electronic control system according to claim 1, in which each slave controller is housed adjacent its corresponding device so that no electrical connection supplying power from the slave controller to the device is exposed.

21. Apparatus comprising an electronic control system according to claim 1, and plural door latches constituting the devices, each having one of said slave controllers.

22. Apparatus comprising an electronic control system according to claim 1, and a steering column constituting the device having one of said slave controllers.

23. Apparatus comprising an electronic control system according to claim 1, and a multiplicity of devices each having one of said slave controllers.
